(19) United States
(12) Patent Application Publication
(10) Pub. No.: US 2004/0205454 A1
(43) Pub. Date: Oct. 14, 2004

(54) System, method and computer program product for creating a description for a document of a remote network data source for later identification of the document and identifying the document utilizing a description

(76) Inventors: Simon Gansky, Berkeley, CA (US); Quinton Y. Zondervan, Boston, MA (US)

Correspondence Address: SILICON VALLEY INTELLECTUAL PROPERTY GROUP, P.O. BOX 721120, SAN JOSE, CA, 95172-1120, US

(21) Appl. No.: 09/942,262

(22) Filed: Aug. 28, 2001

(51) Int. Cl. G06F 17/24

(52) U.S. Cl. 715/500; 715/513

(57) ABSTRACT

A system, method and computer program product are provided for creating a description of a document of a remote network data source for later identification of the document. Information about a document on a remote network data site is received from a user. A document identifier is created based on the user-input information. The document identifier identifies the particular document. A markup language description is retrieved. The markup language description defines properties of elements of a document in a markup language. The document and the content of the document are analyzed utilizing the document identifier and the markup language description. A description of the document is generated based on the analysis. The document description is stored. A system, method and computer program product are also provided for identifying a document. A document is received. Document descriptions of several documents are also received. The document descriptions are compared with the document. A document recognition score is calculated for each of the document descriptions based on a likelihood that the document description matches the document. A document description is selected based at least in part on the document recognition scores. The document is identified based on the selected document description. A system, method and computer program product are provided for identifying documents. A document is analyzed. A description of the document is created based on the analysis. The document is recognized utilizing the document description. A determination is made as to whether the document is in a list of pre-identified documents.

### FIELD OF THE INVENTION

The present invention relates to computer-related transactions, and more particularly to automating computer-related transactions.

### BACKGROUND OF THE INVENTION

The Internet is composed of content distributed in the World Wide Web and various intranets. While a large fraction of the content is static, the truly interesting content is the one that a user can interact with dynamically. This content is of various types including, but not limited to (i) the content stored in various databases, (ii) e-commerce web-pages, (iii) directories, (iv) intranet pages, (v) data warehouses, etc.

The interaction with this dynamic content is accomplished through (i) queries/submissions to databases, (ii) buying/selling/interacting through e-commerce, (iii) running queries and lookups in directories, (iv) accessing and interacting with content resident on intranet pages (including on individual computers), and/or (v) accessing, interacting with, adding, subtracting or modifying content resident in data warehouses.

The access to or interaction with this dynamic content is done in a variety of ways. For example, such interaction may be accomplished through direct access to the databases by running specific commands or through form submissions on the Internet that run specific queries or perform specific actions. This interaction requires the submission of necessary parameters or information to complete a query or interaction (addition, modification, subtraction) with the dynamic content. This information may need to be submitted in multiple steps. Once the submission of information is finished, the results of the interaction/query/e-commerce are sent back to the user.

Each time a user wishes to interact in the foregoing manner, the user is required to carry out each and every one of the steps associated with the submission of necessary parameters or information. If a same type of transaction is to be carried out in a repeated manner, this may be very time consuming and problematic.

Accordingly, accessing web content is more complicated than simply making individual HTTP requests. The prior art has yet to enable fetching of the same content as the user and rendering it the same way the user saw it. To do this, the appropriate content must first be identified. Then it must be fetched across the network. Finally, it must then be rendered correctly.

While the problem may seem simple at a first sight, it turns out to be very complicated. Web pages are mostly dynamic, meaning that the actual content of the page is different from one day to the next. Many pages change even more frequently than that. Furthermore, the document that contains the content may change to the point at which the content would be practically impossible to recognize. Even worse, the content may completely disappear from the document or it may be broken up into several pieces scattered throughout the page. In these two cases, it may be impossible to retrieve the content at all.

In many cases, it is not even clear what the content is. For example, consider a table, which is the first table on the page and has a header labeled “Weather” and a form inside. If a week later, there are 3 different tables on that page, one being the first, one with “Weather” header, and one with the form, then which one is the right one? Just specifying that the table must have all of these three properties will result in error, if one property is missing. Hence, the description of the content must allow for the presence of the majority of the properties to describe the table, not necessarily only the presence of all properties. As another example, consider 2 tables with identical properties, except for minor differences in their inner content and the difference in position. Since the inner content cannot be used to describe a table (it may change every day), the only thing that can be used to differentiate between these two tables is their position. However, this may not be enough. The tables may be exchanged or another similar table may be added to the page. Furthermore, if one of these tables disappears from the page, then the other table will be the best matching table, but it will be a wrong match.

Thus what is needed is a content identification and retrieval mechanism that is robust enough to recognize content in the face of these dramatic changes.

### SUMMARY OF THE INVENTION

A system, method and computer program product are provided for creating an identifier for a document of a remote network data source for later identification of the document. Information about a document on a remote network data site is received from a user. The document can be any type of content, such as a web page or portion thereof, a textual document or portion thereof, database output, etc. A document identifier (referred to herein as the EDD) is created based on the user-input information. The document identifier identifies the particular document. A markup language description (referred to herein as the MLD) is retrieved. The markup language description defines properties of elements of a document (for documents in general) in a markup language such as XHTML. The document and the content of the document are analyzed utilizing the document identifier and the markup language description. A description of the document is generated based on the analysis. The document description is referred to herein as the IDD. The document description is stored for use at run time.

According to one aspect of the present invention, information received from the user includes at least one of: an identification of content of interest in the document, guidelines for recognizing a document, and guidelines for recognizing content elements of interest. According to another aspect of the present invention, the document description contains a list of elements of interest and element properties for the elements of interest.

According to one embodiment of the present invention, the analysis of the content is for identifying elements of interest of the content of the document. Preferably, the markup language description is used to identify properties of each of the elements of interest. Also preferably, the elements of interest of the content are identified based on a conjunction of properties of the element. Particularly, the present invention looks for an element that has all of the properties or the weighted majority.

According to one aspect of the present invention, the document analysis includes comparing the document to at least one other document, wherein the document description is modified to reflect at least one difference between the documents. According to a further aspect, the document is compared to at least one other document, wherein document descriptions of each of the documents are modified to reflect at least one difference between the documents. This allows differentiation between the documents.

In another aspect of the present invention, the document is modified after creation of the document description. The document identifier is modified. The modified document is analyzed for modifying the document description. Preferably, the document analysis includes comparing the modified document to at least one other document. The document description is modified to reflect at least one difference between the documents.

In a further aspect of the present invention, the process is performed during creation of a transaction pattern. Additionally, information about the document can be stored in the document description in terms of properties of an element in the document.

A system, method and computer program product are also provided for identifying a document. A document is received. Candidate document descriptions of several documents are also received. The document descriptions are compared with the document. A document recognition score is calculated for each of the document descriptions based on a likelihood that the document description matches the document. A document description is selected based at least in part on the document recognition scores. The document is identified as being an instance of the selected document description.

According to one aspect of the present invention, the document recognition score is based at least in part on recognizing properties of elements of the documents in the document descriptions, i.e., content recognition. Each of the properties is given a weight. The weights are normalized. Selected elements of the document are each given a content recognition score. The content recognition score is a weighted sum of values returned by a property evaluation function weighted with the normalized weight of the property. The content recognition scores are used to determine whether each content element is present. Preferably, the document recognition score for each document description is calculated using the formula:

$${S}_{k} = {\sum }_{i = 1}^{N} {p}_{i} {R}_{i}$$

where N is a number of elements of interest in the document, pᵢ is the presence weight of element I, and Rᵢ is a function of the content recognition score for element i. Note that the function of the content recognition score could render a result equal to the content recognition score itself.

In a further aspect of the present invention, the selection of the document is based on the document recognition scores and recognition deviation. The deviation is computed from the document recognition scores. The deviation represents how close the second (and third, etc.) best matching retrieval scores are to the preliminarily selected score. Preferably, a document description with a high document recognition score relative to other candidate documents descriptions and a high deviation, i.e., above some threshold, is selected. Also preferably, a documnent description with a low document recognition score and a high deviation is selected. The deviation can be calculated using the formula:

$${d}_{recognition} = {( {\sum }_{i = 1}^{k - 1} \frac{1}{\vert {S}_{i} - {S}_{k} \vert} + {\sum }_{i = k + 1}^{T} \frac{1}{\vert {S}_{i} - {S}_{k} \vert} )}^{- 1}$$

where Sᵢ is the recognition score for document i, k is the index of the matched document, and T is the number of candidate documents.

Pruning can be used for reducing processing. Portions of the document can also be retrieved. Preferably, the portion is retrieved using a content identifier pre-associated with the portion. The content identifier can be associated with the portion in the EDD.

In one aspect of the present invention, the method is performed during replay of a transaction pattern. In another aspect of the present invention, a hint is received. The hint indicates that one document description is more likely to match the document than another document description. The hint can include an order of processing by which one document description is processed in respect to other documents descriptions. The hint can also include a hint threshold, where the hint threshold is a value for determining when a document description matches the document. The hint can also include an order of processing by which one document description is processed in respect to other documents descriptions, and a hint threshold, where the hint threshold is a value that tells the algorithm when the document is matched.

A system, method and computer program product are provided for identifying documents. A document is analyzed at design time. A description of the document is created at design time based on the analysis. At run time, the document is recognized utilizing the document description. A determination is made as to whether the document is in a list of pre-identified documents at run time. Note that the documents in the list have been identified at design time.

A method for identifying content is also provided. Several content elements are received. A content description of a desired content element is also received and compared with the received content elements. A content recognition score is calculated for each of the content elements based on a likelihood that the content description matches the content element. A matching content is selected based at least in part on the content recognition scores.

### BRIEF DESCRIPTION OF THE DRAWINGS

FIG. 1 illustrates a typical hardware configuration of a workstation in accordance with a preferred embodiment;

FIG. 2 illustrates a system for navigating a network, including conducting transactions, in accordance with one embodiment of the present invention;

FIG. 3 is a flowchart of a process for identifying documents according to an embodiment of the present invention;

FIG. 4 is a flow diagram of a process for creating a description of a document of a remote network data source for later identification of the document according to one embodiment of the present invention;

FIG. 5 is a flowchart of a process for identifying a document according to an embodiment of the present invention; and

FIG. 6 is a flow diagram of a process for identifying content according to one embodiment of the present invention.

### DESCRIPTION OF THE PREFERRED EMBODIMENTS

Glossary

| | |
|---|---|
| action | An event which can be executed by the user or by script to change |
| | the state of the remote application (thus changing the state of the |
| | local application). For example, clicking a link. |
| client | A process which makes requests to and, presumably, gets web pages |
| | from the User Agent. |
| content | A Content is an element in a document together with all its |
| | descendants, as a single XML fragment. In other contexts, refers to |
| | any content available on a remote data site. |
| content analysis | Content Analysis is a function of the CRM where an internal |
| | document description (IDD) is produced from the document, its |
| | markup language description (MLD), and its external description |
| | (EDD). The analysis inspects the document and its elements and |
| | looks for relevant features on them, getting hints from MLD and |
| | EDD.The primary objective of the content analysis is to store |
| | enough information about elements on a document, so that they can |
| | be recognized later, amidst some possible changes in the document. |
| content ID | A Content ID is an identifier of a content on a certain document. |
| | While element ID is a local identifier (in the score of a certain |
| | document), a content ID is a considered to be a global identifier by |
| | the CRM. However, the only requirement that the CRM imposes is |
| | that a content ID must be unique within a document. If an element |
| | is to be used by a module outside the CRM, it must be given a |
| | unique content ID. The content ID is a string of alphanumeric |
| | characters. |
| content | Content Recognition is the process of selecting the best element |
| recognition | from a document, given a document's internal description (IDD). In |
| | some cases, content recognition may fail, e.g., if the content has |
| | completely disappeared from the document. Of course, recognizing |
| | an element on a document requires that the current document and |
| | the document that was used to create the IDD are, in fact, the same |
| | document, with some differences that occur on most documents |
| | with time. This may require document recognition first |
| content | A Content Recognition Score is a numeric measure of an element's |
| recognition score | recognition in a document. The value is a number between 0 and 1, |
| | inclusive. A value of 0 means that the element could not be |
| | recognized in the document; a value of 1 means that there has been |
| | a perfect match for the element, i.e. a “perfect recognition”. Any |
| | value in between indicates the success of content recognition. The |
| | closer the value is to 1, the more can one be sure that this is in fact |
| | the correct item. |
| CRM | Content Retrieval Module, a component of the platform. |
| document | An XML document that is written in some markup language is |
| | referred as document. |
| document | Document Analysis is a function of the CRM that extends content |
| analysis | analysis to store some information about the document as a whole, |
| | so that it can be recognized later amongst several candidates. The |
| | content analysis still takes place, but is more complicated. The |
| | recognition of a document depends entirely on presence of certain |
| | elements on it. Hence, the CRM may decide to store information |
| | about elements which were not mentioned in the external document |
| | description (EDD), for the purpose of using those elements in |
| | document recognition. In addition to the document, its MLD, and its |
| | IDD, the document analyzer requires availability of all documents |
| | (together with their MLDs) that the current document can |
| | potentially be confused with. In other words, document analysis |
| | takes place in context of many documents. Thus, the CRM does not |
| | analyze one document in turn. It analyzes a group of documents, |
| | together with their MLDs (which in most cases will be the same) |
| | and their IDDs, and modifies the IDD of every document so that it |
| | can be substantially differentiated from all other documents' IDDs. |
| document ID | A Document ID is a globally unique identifier for a document. |
| document | Document Recognition is a process of selecting an IDD from a list |
| recognition | of IDDs, given a document. The goal is: given document Aₘ select |
| | the IDD which was presumably produced from the document Aₙ, |
| | where Aₘ and Aₙ are in fact the same document, only with minor |
| | changes. Of course, the changes may not be minor; a document can |
| | change beyond recognition. Thus, the CRM provides for some |
| | numeric measurements of document recognition that an external |
| | module (the SRM) can inspect to make a decision whether the |
| | documents are the same or are completely different. After that |
| | determination is made, the CRM can be called to handle content |
| | recognition, but only for a single (presumably correct) document. |
| document | A Document Recognition Deviation is a statistical measure of a |
| recognition | document recognition score deviating from other document |
| deviation | recognition scores. To recognize a document, the recognition score |
| | is computed for every candidate IDD. Then the deviation tells how a |
| | score of one particular IDD deviates from the rest. The deviation is |
| | a real nonnegative number. The closer is the deviation to 0, the |
| | more likely it is that there is another IDD having the same (or very |
| | similar) recognition score. In case where 2 IDDs including the one |
| | given, have the same recognition score, the deviation is defined to |
| | be 0. A high deviation for an IDD with the highest document |
| | recognition score means that this IDD is a very good match, even if |
| | its recognition score is low (nevertheless, it is the highest). |
| | However, a deviation that is close to 0 means that the IDD may not |
| | be the right one (regardless of its recognition score), since there |
| | exists another IDD whose recognition score is very close. In the |
| | special case of a single candidate IDD, the deviation is defined to be |
| | ∞. |
| document | A Document Recognition Hint is a set of values that provide hints to |
| recognition hint | the CRM during document recognition. |
| document | A Document Recognition Score is a numeric measure of a |
| recognition score | document's recognition obtained by comparing a document and an |
| | IDD. This value is a real number between 0 and 1, inclusive. The |
| | higher the value, the better the document matches the IDD. A low |
| | value indicates a low match. In other words, the document |
| | recognition score indicates the certainty that the document |
| | corresponds to this IDD |
| document | Document Similarity is a function of the CRM that allows |
| similarity | comparing two documents to each other and give the comparison a |
| | numeric score in the range from 0 (exclusive) to 1 (inclusive), |
| | where 1 means that the documents are identical. The closer the |
| | score is to 0 the more significant is the difference between the |
| | documents. An external module can test that value against some |
| | threshold to decide whether the documents are in fact the same |
| | (with some minor changes), or they are complelely different. |
| DOM | Document Object Model, a W3C standard for describing XML |
| | documents in an object-oriented fashion. |
| DTD | Document Type Definition, a document used to define an XML |
| | markup language. It contains the rules by which an XML |
| | Document of the corresponding markup language is |
| | constructed/validated. |
| element | An XML element. Everything from <tag> to </tag> |
| element ID | Element ID refers to an identifier that uniquely identifies an element |
| | in a document. The element ID is a non-negative number |
| EDD | An External Document Description (EDD) is a description of a |
| | document and some of its elements from the user's point of view. |
| | The module using the CRM is responsible for creating appropriate |
| | EDDs and/or passing them to the CRM. |
| IDD | An Internal Document Description (IDD) is a description of a |
| | document and some of its elements from the internal (the CRM's) |
| | point of view. It contains all properties of all elements of interest in |
| | a format optimized for internal usage. The IDD is created by the |
| | CRM from a document, using an EDD and the appropriate MLD. |
| | The IDDs gets created at design time and stored for later use. At run |
| | time, an IDD is the only information about a document, so both |
| | content recognition and document recognition deal only with IDDs. |
| markup language | An XML Schema or DTD, which defines certain grammatical rules |
| | for how to construct or validate an XML document that can be set to |
| | be “of” the markup language, or “compliant with” or “formatted |
| | according to” or “an instance of” the markup language. |
| markup language | The Markup Language Description (MLD) refers to an XML file |
| description | that describes a particular markup language. This file is not the |
| | DTD of the language; it is merely a mechanism to tell the CRM |
| | some properties of the markup language, such as specifying which |
| | elements are extremely rare, which are very common, what data |
| | types do attributes have and how can they change, etc. The CRM |
| | uses the MLD when analyzing a document and/or content. The |
| | MLD tells the CRM what feature of the document can be relevant |
| | and which are usually irrelevant. There is exactly one MLD file per |
| | every markup language. |
| presence weight | Every element that the CRM needs to locate is given a Presence |
| | Weight, which is the significance of that element's presence in |
| | document recognition. The presence weight is a number between |
| | greater than 0 and not greater than 1. The implicit root element |
| | never has a presence weight associated with it, since the CRM |
| | locates it without the process of content recognition. |
| property | A Property is the smallest unit of internal document description |
| | (IDD). It describes a single feature of an element. Every property is |
| | uniquely identified in the context of a document by its ID (a class |
| | name) and its property attributes (definition follows). |
| property attribute | Every property has zero or more Property Attributes, which are a set |
| | of values in which context the evaluation function will be evaluated. |
| | For example, a property that states “The ‘border’ attribute must be |
| | equal to ‘0’” will have 2 attributes: a string “border” and a string |
| | ‘0’. The property attributes are of 2 types: |
| | Computable Property Attributes - these attributes are not |
| | required, since they can be computed directly from the |
| | document. Using the previous example, the attribute ‘0’ is a |
| | computable property attribute, since if it not specified, the |
| | CRM will use the value of the ‘border’ attribute, as it exists |
| | in the element. It is highly recommended that the CRM |
| | computes the computable property attributes on its own, to |
| | avoid errors. Moreover, a computable property attribute may |
| | be stored in some format specific to the class implementing |
| | the property. Hence, explicitly specifying a computable |
| | attribute requires knowledge of that format. Nevertheless, |
| | the CRM allows for the computable property attributes to be |
| | specified explicitly (using the IDT). |
| | Required (Incomputable) Property Attributes - these |
| | attributes are required whenever a property is referenced, |
| | since they cannot be computed from the document. Using |
| | the previous example, the attribute ‘border’ is an example of |
| | a required property attribute, since it uniquely identifies the |
| | element's attribute to use. Without it, the CRM would have |
| | no knowledge which attribute of the element should be |
| | compared with “0”. |
| | A property identifies its attributes by the attribute name. In the |
| | example, the names would be “name” and “value”, i.e. |
| | name = “border”, value = “0”. |
| property | A Property Evaluation Function is associated with every property. |
| evaluation | The function takes an element in document and returns a numeric |
| function | value between 0 and 1, which is based on how well does that |
| | element satisfies the property. Some properties can be Boolean, in |
| | which case their evaluation function returns 0 (false) or 1 (true), |
| | while other properties are not Boolean, in which case the function |
| | returns an intermediate value. The higher is the value, the better |
| | does the property hold for that element. A property evaluation |
| | function does the evaluation in context of some values, specific to |
| | that property, called the property attributes (definition follows). |
| property weight | Each property has a Property Weight associated with it, which |
| | indicates the significance of that property. The weight is specified |
| | as a real number between 0 and 1, exclusive. |
| remote | An application, which exists on some remote site and has some |
| application | functionality of interest that the user of the platform desires to |
| | extract from it. (For, example Yahoo Mail is a remote web |
| | application). |
| remote state | Corresponds to a stable output from a remote application at some |
| (remote output) | point in time. (In case of Yahoo Mail, the login page is one state and |
| | the page, which displays the Inbox, is another state.) |
| root element | In every document, there is an implicit element, called the Root |
| | Element, which always has its element ID equal to 0. The root |
| | element does not appear anywhere in the document, but it is used as |
| | if it was there. This pseudo-element has a pseudo-attribute with the |
| | name “url”, which is the URL of the document. In a tree of a |
| | document, the root element is always the top-level element. |
| UA | The User Agent, a component of the platform. Used to fetch the |
| | output from a remote application and execute any user actions on |
| | that output. |
| web content | See content. |
| XHTML | Extensible HyperText Markup Language, an XML-compliant |
| | version of HTML. XHTML is viewable on major browsers. |
| XML | Extensible Markup Language, a syntax for creating SGML- |
| | compliant markup documents. The rules by which a document is |
| | constructed/validated can be specified via a DTD or XML Schema. |
| | XHTML is an example of an XML compliant markup language. |
| | XML documents may also be created which do not correspond to an |
| | explicitly defined schema. Such documents are said to be well- |
| | formed if they conform to the syntactical rules of XML, but their |
| | overall structure can be arbitrary. |

Illustrative System Architecture

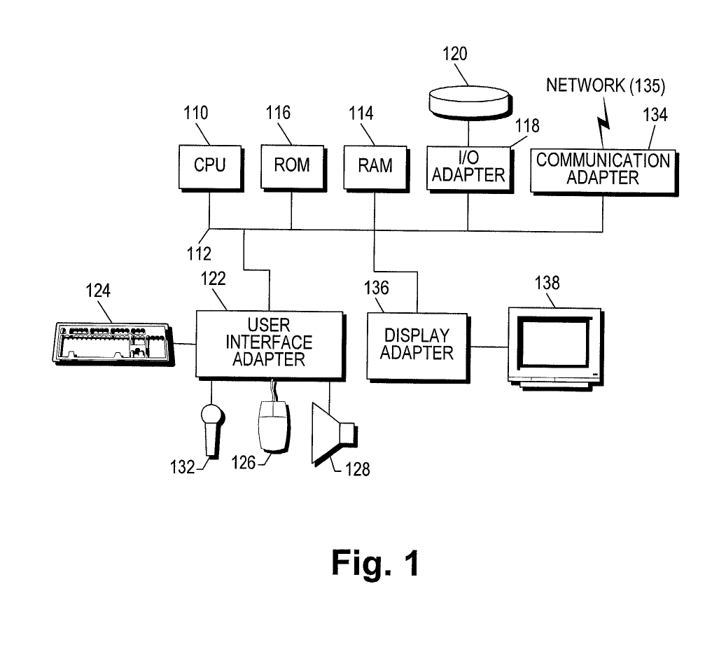

FIG. 1 illustrates a typical hardware configuration of a workstation in accordance with a preferred embodiment having a central processing unit 110, such as a microprocessor, and a number of other units interconnected via a system bus 112.

The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 328, a microphone 132, and/or other user interface devices such as a touch screen (not shown) to the bus 112, communication adapter 134 for connecting the workstation to a communication network 135 (e.g., a data processing network) and a display adapter 136 for connecting the bus 112 to a display device 138.

The workstation typically has resident thereon an operating system such as the Microsoft Windows NT or Windows Operating System (OS), the IBM OS/2 operating system, the MAC OS, or UNIX operating system. Those skilled in the art may appreciate that the present invention may also be implemented on platforms and operating systems other than those mentioned.

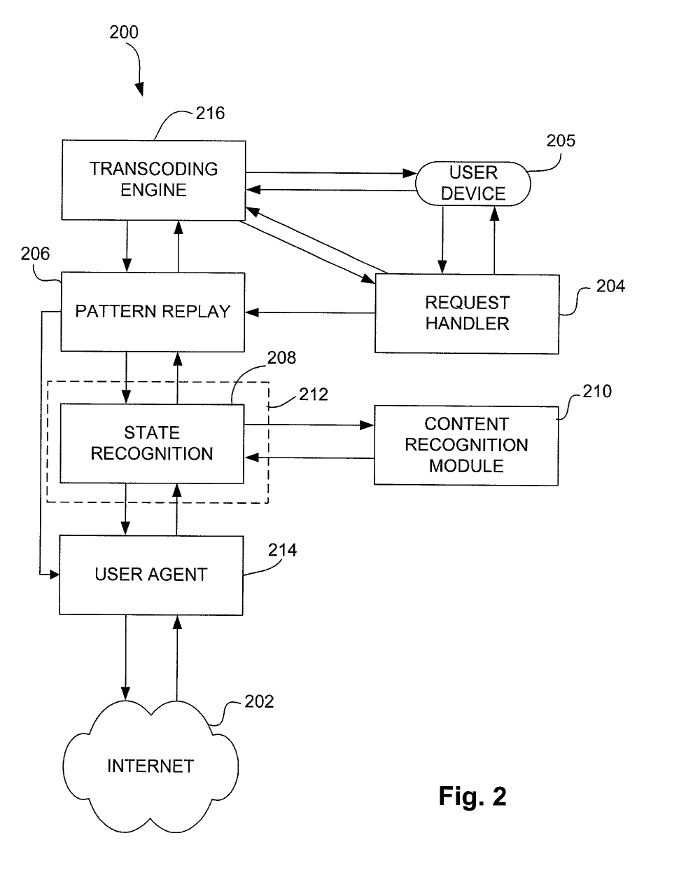

FIG. 2 illustrates a platform 200 for navigating a network 202, including conducting transactions, in accordance with one embodiment of the present invention.

A Request Handler (RH) 204 communicates with a user device 205. The RH manages requests from the user device, routing them to the appropriate system component. When a user requests a transaction, the request is sent to a Pattern Replay Engine (PRE) 206, which replays a pattern for conducting a transaction on behalf of a user. More information about operation and functionality of the PRE is found in U.S. patent application entitled SYSTEM, METHOD AND COMPUTER PROGRAM PRODUCT FOR PATTERN REPLAY USING STATE RECOGNITION, filed concurrently herewith and Provisional U.S. patent application entitled SYSTEM, METHOD AND COMPUTER PROGRAM PRODUCT FOR THE RECORDING AND PLAYBACK OF TRANSACTION MACROS, filed Apr. 12, 2001, each of which is assigned to common assignee Clickmarks, Inc., and which are both herein incorporated by reference.

The State Recognition Module (SRM) 208 determines which state a website is in based on its current output, such as a structure of the current output. The SRM may communicate with a Content Recognition Module 210, which recognizes states based on the actual content of the output of a website rather than the structure of the output. A Connector 212 is in communication with the SRM. The Connector executes a state in the pattern. The SRM, Content Recognition Module, and connector are described in detail below.

The User Agent 214 is used by other components of the system to provide the actual interaction with a remote website. For example, when replaying a pattern, the SRM communicates with the User Agent via the Connector to provide instructions to the User Agent. The other system components have intelligence built into them that instructs them how to utilize the User Agent. For example, when a user clicks on a button on a page, other components instruct the User Agent to navigate to the desired web page and perform some action, such as filling in a form. The User Agent retrieves the resulting page and returns it to the other components.

By default, the User Agent is not running. A listener (not shown) listens for requests. When the listener receives a request, it creates a new User Agent process on the server and returns an identifier that identifies the User Agent process. Subsequently, client processes use the identifier, go to the specific User Agent and instruct it to perform some action. The User Agent performs the action according to the instructions and returns the results of the action.

A Transcoding Page Rending Engine (TRE) 216 renders content for display on the user device. Preferably, the TRE is able to render content on any display environment. More information about operation and functionality of the TRE is found in U.S. patent application entitled SYSTEM, METHOD AND COMPUTER PROGRAM PRODUCT FOR PAGE RENDERING UTILIZING TRANSCODING, filed concurrently herewith and assigned to common assignee Clickmarks, Inc., and which is herein incorporated by reference.

In the present invention, a transaction preferably refers to communicating (i) information and/or actions required to conduct the transaction, and/or (ii) information and/or actions sent back or desired by the user, respectively.

For example, a transaction, in one embodiment, may refer to: information submitted by the user, actions taken by the user, actions taken by a system enabling the access of the user to the data, actions taken by the data to retrieve/modify content, results sent back to the user, and/or any combination or portion of the foregoing entities.

Content Retrieval Module

This section describes the Content Retrieval Module, defines its main functionalities, states several assumptions, and defines the CRM-specific terms used in this document.

Purpose of the CRM

One of the functionalities of the platform is to retrieve an arbitrary content from a remote web page and send it to a specific device in a format suitable for that device. The formatting is done by another module in the platform, namely, the Universal Transcoder, which is described in U.S. patent application entitled SYSTEM, METHOD AND COMPUTER PROGRAM PRODUCT FOR PAGE RENDERING UTILIZING TRANSCODING, discussed above. The purpose of the Content Retrieval Module (abbreviated as CRM) is to retrieve the content as an XML stream for use by other platform modules. Particular modules that directly use the CRM are the State Recognition Module (SRM) and the Interactive Development Tool (IDT), which are described above.

While the problem may seem simple at a first sight, it turns out to be very complicated. The web pages are mostly dynamic, meaning that the actual content of the page is different from one day to the next. Many pages change even more frequently than that. Furthermore, the document that contains the content may change to the point at which the content would be practically impossible to recognize. Even worse, the content may completely disappear from the document or it may be broken up into several pieces scattered throughout the page.

In many cases, it is not even clear what the content is. For example, consider a table, which is the first table on the page and has a header labeled “Weather” and a form inside. If a week later, there are three different tables on that page, one being the first, one with “Weather” header, and one with the form, then selecting the correct one could be problematic. Just specifying that the table must have all of these three properties will result in error, if one property is missing. Hence, the description of the content must allow for the presence of the majority of the properties to describe the table, not necessarily only the presence of all properties. As another example, consider two tables with identical properties, except for minor differences in their inner content and the difference in position. Since the inner content cannot be used to describe a table (it may change every day), the only thing that can be used to differentiate between these two tables is their position. However, this may not be enough. The tables may be exchanged or another similar table may be added to the page. Furthermore, if one of these tables disappears from the page, then the other table will be the best matching table, but it will be a wrong match. The CRM is designed to be robust enough to recognize content in the face of these dramatic changes.

Another functionality of the CRM is to recognize an XML document among several candidates (this functionality is used by the SRM). This is easy if the documents are very different from each other. However, there are some cases when the documents are very similar. By describing the documents in a way that allows the retrieval algorithm to successfully differentiate between them, the problem is certainly easier than retrieving content from the document.

In practice, however, the real problem is a lack of knowledge of all the candidate documents. The list of possible candidates may be very carefully formed, but still it is never complete. A remote site may just return a totally new document. Now, a serious problem is presented. If the XML document does not look like any of the candidates, then it can be either a totally new document or a document in the list that has been significantly changed. The present invention provides mechanisms to determine which case that is. One solution is to combine the document recognition and content recognition together in one algorithm and then try to locate each content on each candidate. If the current document would have most of the contents that are associated with a certain candidate, then there is certainty to some degree that the document is a good match. In practice, this works because the main purpose of recognizing the document is to act on its contents. Therefore, the fact that a certain set of contents has been found on the document is exactly what allows us the present invention to act on that document. This approach is implemented in the present invention. The document recognition and content recognition takes place at the same time. The present invention is also able to recognize the document first, and then look for the content elements on it. This process is more efficient. Furthermore, some pruning is involved which allows a more efficient implementation.

Naturally, a content and document can be defined in terms of descriptions of those, i.e. some features that the document and/or content needs to have that would allow the algorithm to recognize them. Of course, the problem of specifying what features the document must have, what features it may have, and what features it does not have should be done very carefully. The features should describe the document's structure as well as allow differentiating between this document and another one. The same thing applies to individual elements on the document. Therefore, besides being able to recognize the document and some of its elements given some descriptions of those, it should be able to intelligently generate those descriptions, or “analyze” the document. One problem is that it is very difficult (if possible in general) to predict the document's possible changes in the future, and some user input may be necessary to guide the CRM when it attempts to describe a document and its elements.

When a designer is using the IDT to create an application, he or she may encounter a handful of different document. Some of the documents may be identical, and some may differ only slightly. For example, a script on the document can slightly modify it, and the resulting document is not the same as the original one. As another example, a remote application can change a document while the designer is working with the IDT, which means that the designer is faced with two different documents which are associated with an identical state of a remote application (they even can have identical URL). As the designer designs an application on the IDT, each new document is added to the list of documents used by the application; but the IDT and the SRM detect that a document is already present in the list and add it if it is not on the list.

The CRM allows detecting a document's presence in a list of documents using two approaches: try to recognize the document in the list using the CRM's document recognition algorithm, or compare the document to every document in the list and inspect the comparisons. The first approach is more logical, but it requires that every document in the list have been already analyzed, which implies that every time a new document is added, it needs to be analyzed. Furthermore, a document analysis is based on other documents that it may be confused with, since the description of the document obtained through the analysis must differentiate it from other documents. Therefore, every document may need to be reanalyzed every time a new document is added to the list.

The second approach is to compare two documents to each other and measure their similarity along some numeric scale. Then the IDT and the SRM may decide whether the new document needs to be added. If a new document is checked against the list of all the documents that an application designer has collected so far, the SRM or the IDT can impose their conditions on the maximum allowed measure of similarity. If the similarity is lower than some threshold, it is likely that the document is new to the list. However, if the similarity score is high, that means that a very similar document is in the list, and the IDT may prompt the application designer for confirmation whether they both are the same document or not. As a special case, both documents may be identical (in which case the similarity measure would be at its highest possible value), which means that the document is added to the list with a special identifier to assist the CRM in differentiating between the two identical documents.

Hence, the CRM's main functionality consists of three parts: analyze document at design time and describe it in some format, recognize document and its elements at runtime using the description obtained in the analysis part, and determine if a document is in the list of documents encountered at design time. Each of these functions is described in detail below. For design purposes, the analysis and recognition are broken down in two parts each: one for document analysis/recognition, and one for content analysis/recognition.

The following description describes the high-level design of the CRM. The design is specified in terms of higher-level algorithms used to implement the following functionalities of the CRM:

1. Content Analysis—collect information about a document's elements and store it in some predefined format. This information shall be sufficient to recognize those elements on the document amidst various changes the document may undergo.

2. Content Recognition—given the information about a document's elements that was collected in a prior content analysis, use it to locate those elements on a document that may have been modified since the time the content analysis has occurred.

3. Document Analysis—collect information about a document as a whole and store it in some predefined format. The information shall be sufficient to recognize the document in future and differentiate it from other documents, amidst any changes it may undergo.

4. Document Recognition—given the information about a document that was collected in a prior document analysis, use it to recognize the document that could have been modified since the time it was analyzed.

5. Document Similarity—given two documents, compare them and obtain the score of document similarity, which is a number between 0 and 1. A higher value of the similarity score indicates that the documents are similar; a score of exactly 1 means that the documents are identical.

There is a separate section dedicated to the design of each of the aforementioned functionalities. The sections should be read in the order they appear in the document, even though it is not the same order as above. A separate section is dedicated to the main ideas in the CRM design as well as to the XML schemas used by the CRM to communicate with the IDT and to store information in a non-volatile storage. This section should be read before any section on the design, as it provides an overall idea of how the CRM functions. Illustrative XML schemas are set forth in the appendices and cab be used as reference.

Assumptions

The following assumptions about input document can be used in the CRM:

1. The document is a well-formed XML. See XML specification for details.

2. All attributes come in attribute-value pairs. For Boolean attributes, the attribute name is used as the value.

3. All attribute values are quoted by a double-quote.

4. The document has no DTD elements in it. The IDOCTYPE element should be removed from the document before it is passed to the CRM.

5. The document has no comments embedded within XML elements.

6. The document is not required to have a single top-level element. The CRM is designed to work with XML fragments (well-formed) as well.

7. Every element has an identifying attribute with a unique value. The value is the element ID, and the name of the attribute must be defined in the MARKUP element of the MLD for that language.

8. It is not the CRM's responsibility to validate the document. The validation is optional and can be done by an external module.

CRM Design

This section gives a general overview of the CRM design, along with brief descriptions of the XML schemas used in the CRM. Illustrative XML schemas and a list of possible properties are provided in the appendices.

Principles of the CRM Design

There are two different times where the CRM functionality is used: the application design time and the application run time.

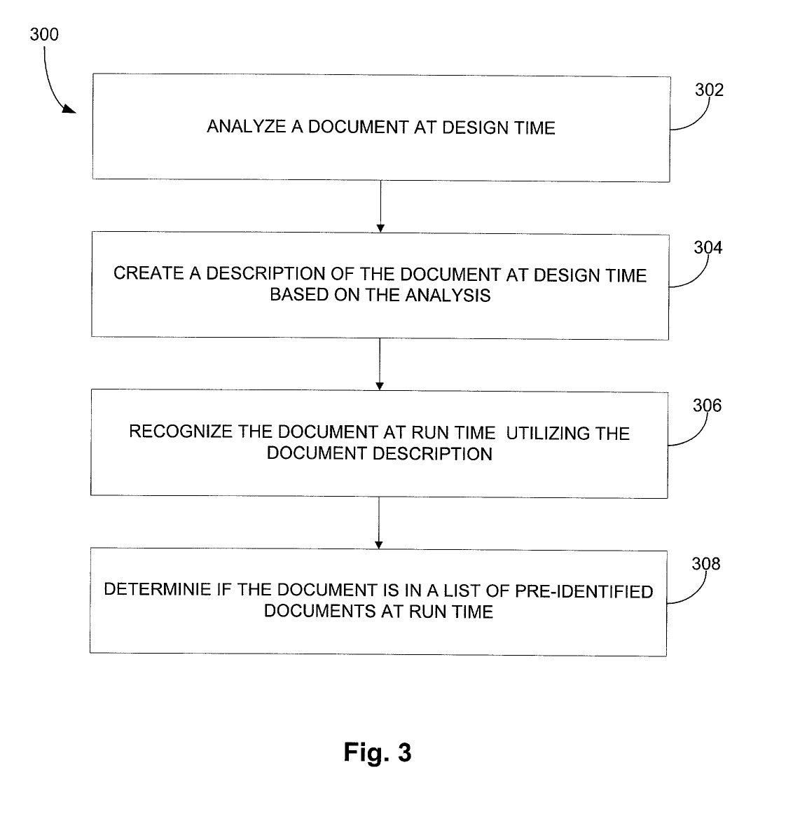

FIG. 3 is a flowchart of a process 300 for identifying documents. In operation 302, a document is analyzed at design time. In operation 304, a description of the document is created at design time based on the analysis. At run time, the document is recognized utilizing the document description in operation 306. In operation 308, a determination is made at run time as to whether the document is in a list of pre-identified documents. Note that the documents in the list have been identified at design time.

Application Design Time

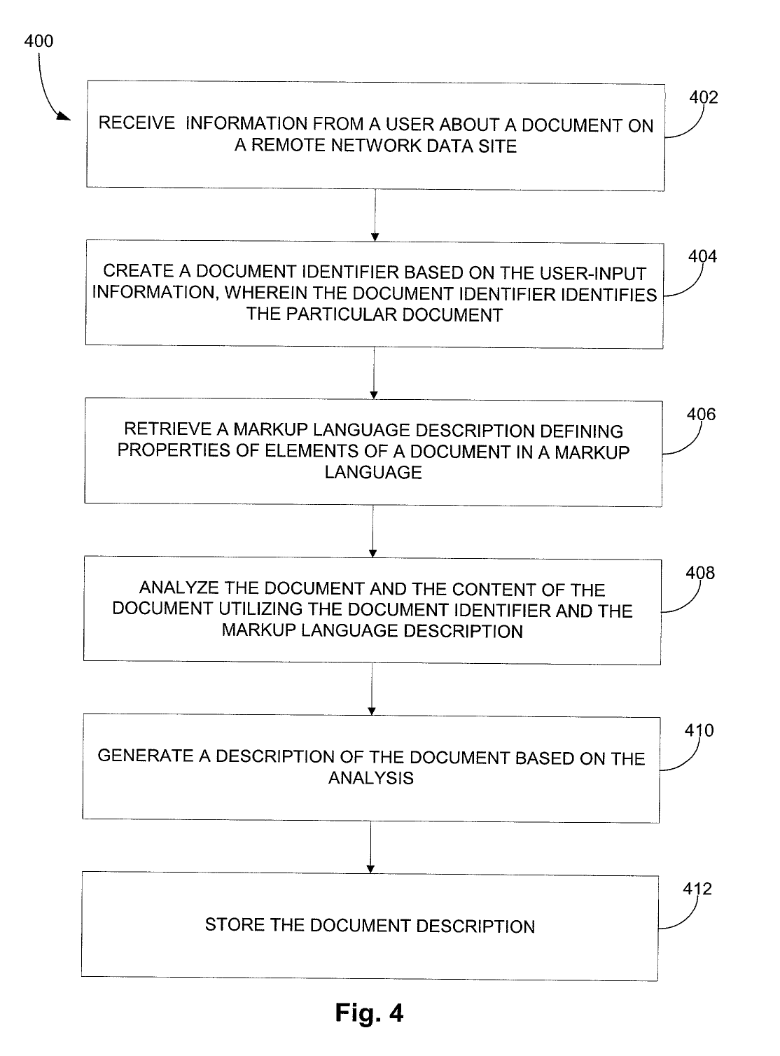

FIG. 4 is a flow diagram of a process 400 for creating a description of a document of a remote network data source at design time for later identification of the document. Information about a document on a remote network data site is received from a user in operation 402. The document can be any type of content, such as a web page or portion thereof, a textual document or portion thereof, database output, etc. In operation 404, a document identifier (referred to herein as the EDD) is created based on the user-input information. The document identifier identifies the particular document. A markup language description (referred to herein as the MLD) is retrieved in operation 406. The markup language description defines properties of elements of a document (for documents in general) in a markup language such as XHTML. The document and the content of the document are analyzed in operation 408 utilizing the document identifier and the markup language description. A description of the document is generated in operation 410 based on the analysis. The document description is referred to herein as the SDD. In operation 412, the document description is stored for use at run time.

According to one embodiment of the present invention, information received from the user includes at least one of: an identification of content of interest in the document, guidelines for recognizing a document, and guidelines for recognizing content elements of interest. According to another embodiment of the present invention, the document description contains a list of elements of interest and element properties for the elements of interest.

According to one embodiment of the present invention, the analysis of the content is for identifying elements of interest of the content of the document. Preferably, the markup language description is used to identify properties of each of the elements of interest. Also preferably, the elements of interest of the content are identified based on a conjunction of properties of the element. Particularly, the present invention looks for an element that has all of the properties or the weighted majority.

According to one embodiment of the present invention, the document analysis includes comparing the document to at least one other document, wherein the document description is modified to reflect at least one difference between the documents. According to a further embodiment, the document is compared to at least one other document, wherein document descriptions of each of the documents are modified to reflect at least one difference between the documents. This allows differentiation between the documents.

In another embodiment of the present invention, the document is modified after creation of the document description. The document identifier is modified. The modified document is analyzed for modifying the document description. Preferably, the document analysis includes comparing the modified document to at least one other document. The document description is modified to reflect at least one difference between the documents.

In a further embodiment of the present invention, the process is performed during creation of a transaction pattern. Additionally, information about the document can be stored in the document description in terms of properties of an element in the document.

In more detail, during the application design, the IDT collects information from the user about a certain document. This information includes the contents of interest (each content is identified internally by an element ID), the guidelines for recognizing a document, and the guidelines for recognizing the content elements of interest. All this information is passed to the CRM (through the SRM, which does not change anything) as a single XML fragment, called the External Document Description, or the EDD. The CRM then analyzes the document and return some description of it that will be stored in overall application schema for use at the run time.

However, the CRM does not necessarily recognize a document or content using the EDD, since the EDD may have very little or no information. To complement the EDD, there exists a global XML file, called the Markup Language Description, or the MLD, which is defined for every markup language the CRM can deal with. For example, there is only one MLD for the XHTML 1.0, the language that is of the primary interest to the CRM in a preferred embodiment. The MLD describes the language in general, regardless of any particular document, while the EDD describes only a certain document. Furthermore, the MLD tells the CRM what properties to use for each element in the document. For an example, the CRM has no knowledge that there is only one “title” element in any XHTML document. To know that, the “title” element must be described in the MLD as being always present in the document and as being unique (which implies that there is one and only one such element in every XHTML document). Moreover, the description of a “title” element in the MLD places very high priority on properties of its inner text, which is a very crucial differentiating factor in XHTML document recognition.

As another example, consider the XHTML elements “input” and “table”. The input element can be placed anywhere (at least, with attribute “type” set to “hidden”), without affecting the layout or structure of the page. In contrast, a “table” element is a block in an XHTML document that must abide by a certain structure. Moreover, the table structure does not change very rapidly on most sites, and a table structure can be very helpful in locating an element. Hence, in one embodiment, the CRM must know that the document structure in terms of the “table” tags must be considered, while the structure of “input” tags can be ignored altogether.

Accordingly, the CRM is using the MLD to complement the EDD for the purposes of document and content recognition. If the EDD were almost empty, the CRM would use description of elements from the MLD to generate default document description (“default” in the sense that no user input was given to it).

After the CRM analyzes the document (using the document itself, its EDD, and the MLD for the language), it creates an XML fragment with a detailed description of the document. This XML is called the Internal Document Description (or the IDD), to differentiate it from the EDD. The IDD contains the list of all elements of interest, and a list of element properties for every element of interest. The format of IDD is optimized for fast parsing and processing during the run time. Since the IDD will be stored as a part of a larger XML file, it has its own namespace “CRM”, i.e. every IDD tag begins with “CRM:”.

The process of creating the IDD involves the content analysis and document analysis. The content analysis is concerned with ensuring that the IDD contains enough information to identify every element of interest on the document. Furthermore, the content analysis is concerned with identifying document among a single candidate, since a remote application can always return a totally unknown document. However, the content analysis does not deal with differentiating between several documents. That is the purpose of the document analysis, where all the documents are compared pair wise and their IDDs are modified to reflect the differences between the documents.

For the purposes of the SRM, the CRM provides a facility for comparing two documents (actual documents, not IDDs or EDDs). The comparison is based on normalized real number scale, where a high value indicates close similarity. The similarity function is defined to return 1 if and only if both documents are identical, which is expected to prevent the SRM from asking the CRM to analyze two identical documents.

In case an adjustment is needed to the IDD after the initial application design, the procedures are similar to the initial design itself. Since the IDT's project file contains the original EDD, and since the IDT has a copy of the actual document (as it was during the initial design) stored in its project file, the user has all the information needed for updating this document without having to add all contents again. The procedure is as follows: the IDT passes the document and (modified) EDD to the CRM for re-analyzing. Furthermore, any modification to the EDD requires not only content analysis to the document, but also the document analysis for the entire document set. The repetition of the document analysis is also required when a new document is added to the set.

However, the user may decide not to use the old document and use its newer version. Unfortunately, this requires the user (and the IDT) to repeat the addition of content elements to the EDD and to repeat the document analysis, i.e. re-analyze the entire document set.

Application Run Time

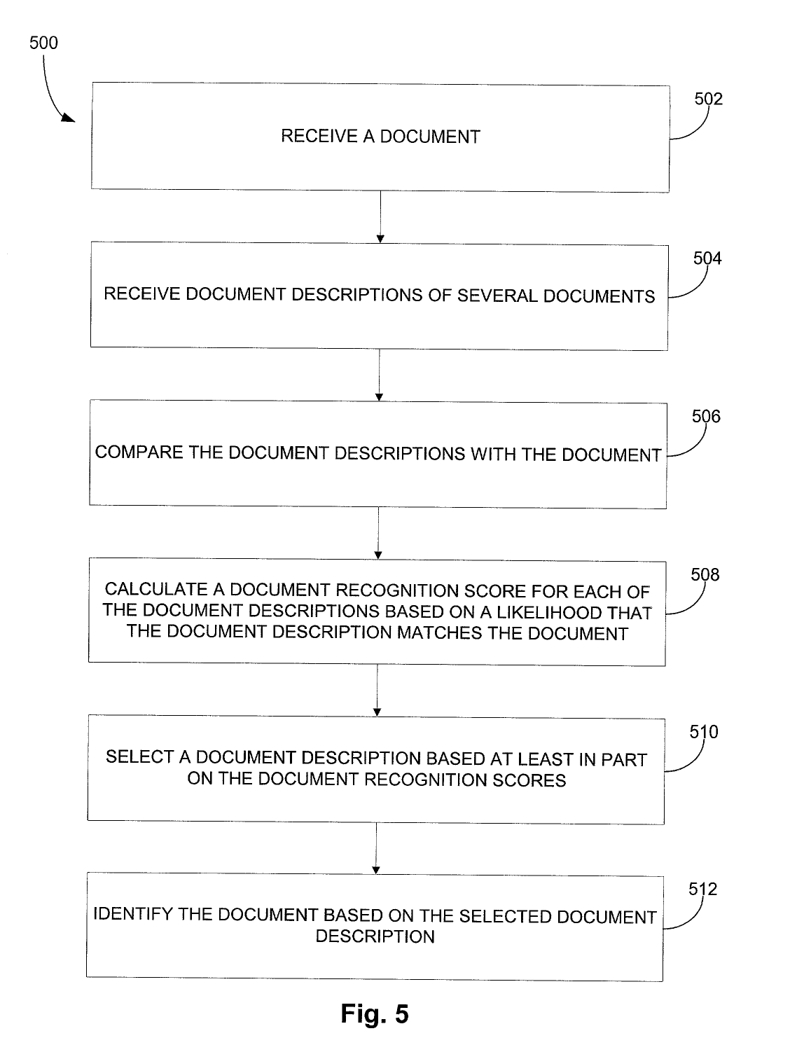

FIG. 5 is a flowchart of a process 500 for identifying a document at run time. A document is received in operation 502. Candidate document descriptions of several documents are received in operation 504. In operation 506, the document descriptions are compared with the document. In operation 508, a document recognition score is calculated for each of the document descriptions based on a likelihood that the document description matches the document. A document description is selected in operation 510 based at least in part on the document recognition scores. In operation 512, the document is identified based on the selected document description.

According to one embodiment of the present invention, the document recognition score is based at least in part on recognizing properties of elements of the documents in the document descriptions, i.e., content recognition. Each of the properties is given a weight. The weights are normalized. Selected elements of the document are each given a content recognition score. The content recognition score is a weighted sum of values returned by a property evaluation function weighted with the normalized weight of the property. The content recognition scores are used to determine whether each content element is present. Preferably, the document recognition score for each document description is calculated using the formula:

$${S}_{k} = {\sum }_{i = 1}^{N} {p}_{i} {R}_{i}$$

where N is a number of elements of interest in the document, pᵢ is the presence weight of element I, and Rᵢ is the content recognition score for element i.

In a further embodiment of the present invention, the selection of the document is based on the document recognition scores and recognition deviation. The deviation is computed from the document recognition scores. The deviation represents how close the second (and third, etc.) best matching retrieval scores are to the preliminarily selected score. Preferably, a document description with a high document recognition score and a high deviation is selected. Also preferably, a document description with a low document recognition score and a high deviation is selected. The deviation can be calculated using the formula:

$${d}_{recognition} = {( {\sum }_{i = 1}^{k - 1} \frac{1}{\vert {S}_{i} - {S}_{k} \vert} + {\sum }_{i = k + 1}^{T} \frac{1}{\vert {S}_{i} - {S}_{k} \vert} )}^{- 1}$$

where Sᵢ is the recognition score for document i, k is the index of the matched document, and T is the number of candidate documents.

Pruning can be used for reducing processing. Portions of the document can also be retrieved. Preferably, the portion is retrieved using a content identifier pre-associated with the portion. The content identifier can be associated with the portion in the EDD.

In one embodiment of the present invention, the process is performed during replay of a transaction pattern. In another embodiment of the present invention, a hint is received. The hint indicates that one document description is more likely to match the document than another document description. The hint can include an order of processing by which one document description is processed in respect to other documents descriptions. The hint can also include a hint threshold, where the hint threshold is a value for determining when a document description matches the document. The hint can also include an order of processing by which one document description is processed in respect to other documents descriptions, and a hint threshold, where the hint threshold is a value that tells the algorithm when the document is matched.

In more detail, during the run time, the SRM passes IDDs obtained at the design time to the CRM for document identification. As a new document arrives and need to be recognized, the SRM passes that document to the CRM, along with all the IDDs of the candidates and some optional hints. The CRM assigns a document recognition score to every candidate IDD, which is compared by the SRM to some threshold. Naturally, the SRM can expect to assume that the IDD with the highest document recognition score matches the document. However, this may not necessarily be the case. The SRM is responsible for inspection of the recognition score and a recognition deviation to make the decision. There can a variety of cases:

High recognition score and high deviation—the IDD is a good match, since it has the highest score and no other IDD had a score near that.

High recognition score and low deviation—the IDD may not necessarily be the correct match, since there exists another IDD (at least one) whose recognition score was about the same.

Low recognition score and high deviation—the IDD is the best, but it only remotely matches the document.

Low recognition score and low deviation—it is very likely that the document does not match any IDD.

Of course, there are many intermediate cases, which are left to the designer of the SRM. The section on document recognition discusses how the deviation and the document recognition score are computed. The present invention also provides a function unifying the document deviation and the document recognition score together into a Boolean function. The SRM then will be guided by the result of that function. A success means that the document is a positive match; a failure indicates that the document is not in the list of candidates. The present invention includes a variety of possible functions for that; the simplest possibility is to multiply the recognition score and the deviation and return success if and only if the product is above some threshold, which is determined experimentally.

After the SRM picks an IDD that matches the document, it can ask the CRM to retrieve individual contents from that document. A content can only be retrieved by passing its global content ID to the CRM. Therefore, every content that will ever need to be retrieved should be given a content ID at the design time, which is placed in the EDD of the document by the application designer.

The CRM assumes that all elements of interest in a given document are unique at all times. Therefore, it guarantees not to have any many to one matches, where several content IDs would match the same content. If it cannot find a content, it returns a null value when asked for it. Internally, the CRM assigns a content recognition score to every content it locates, and later tests it against its own thresholds. For more details, see the section on content recognition. If the test fails, the CRM assumes that the match was wrong, and since it was the best match for the given element, it returns null. As a special case, the content retrieval will fail if the document has no elements with the same name as the element asked for, or if all such elements have been matched to other contents previously. The consequence is that a content that is located first has more choices that any consecutive content with the same element name.

As discussed in the subsection on the design time, if a document has been dramatically changed, the document and its elements of interest may need to be reanalyzed from scratch. This would require re-analysis of all the documents in the pattern.

Properties of Elements

The information about a document is stored in the IDD in terms of properties of an element in that document. Almost all properties of a document can be described in terms of properties of its individual elements. For example, the title of an XHTML document is just the inner text of the “title” element, which is the one and only such element on an XHTML document. However, some properties are specific to the document, e.g. the URL of the document, which may not be present anywhere in the document (except maybe comments). Thus, an implicit root element is introduced, which serves 2 functions:

1. Its attributes describe those features of the document that cannot be described by any element in it, e.g. attribute “url” has the document's URL as its value.

2. It provides for the CRM to work with XML multiple elements as well as individual elements, since the multiple automatically becomes a single type of element when the root element is assumed the top-level element in all documents.

An individual property is the smallest unit of information about a document. It consists of the following:

The property evaluation function, which determines if an element has that property. The function is not necessarily a Boolean. It can return any value between 0 and 1, which indicates how closely the element is to having that property. The higher the value, the better the property holds for the element.

Property attributes that describe the property and in which context the evaluation function will be executed.

Attribute constructor, which sets the values of computable property attributes when they are not explicitly specified.

Property ID, which is a name of the class that implements the evaluation function and the attribute constructor.

As a property is being referenced, an appropriate class is loaded and an instance of it is created from the required attributes. The property attribute constructor then sets the values for all computable property attributes, as needed by the property's definition. After that, the evaluation function may be called on any element in the document.

The CRM is designed to work with completely arbitrary properties. The module allows for adding new properties to the CRM, as one pleases. To add a property, one only needs to implement appropriate property class (evaluation function and constructor). To use it, one needs to add the property in the MLD and/or EDD (see below for details).

Associated with every property is the property weight, which tells the CRM the importance of that property. The weight is set by the CRM alone, but the EDD and MLD may give certain requirements on the weight.

If a certain element has N properties, then the CRM recognize the element based on the conjunction of those properties. The CRM looks for an element that has all of the properties (or the weighted majority).

According to a preferred embodiment, a disjunction-like identification of properties is supported. More particularly, rather than requiring the element to have either property A or property B (or both) in order for it to be recognized, the present invention provides two alternative methods:

1. Many properties, especially ones associated with text, have a regular expression as a required property attribute. One can use a regular expression to achieve the effect of disjunction.

2. When a regular expression cannot express the disjunction, and when the needed disjunction consists of simple atomic properties, one can define a totally new property, with an arbitrary behavior. For example, one can define the property evaluation function that would use other properties and return their disjunction.

A special “FALSE” property is implicitly assumed by the CRM for the purpose of minimizing errors. If an unknown property is referenced, then the “FALSE” property is used instead. The “FALSE” property is defined to always return 0.

When a new property is added, no change to existing properties takes place, since it would affect the behavior of the CRM for documents whose IDD was generated previously.

Internal Document Description

The IDD contains the list of all properties for every element on interest on the document. For efficiency reasons, the properties are sorted within their owner element by their weight, and the elements are sorted by their presence weight. For more information behind this, see the discussion on pruning in the content recognition section.

A property in the IDD is the property ID and the values of all property attributes, computable and incomputable. The computable attributes get their value from the CRM at the design time, by inspecting the document.

At the runtime, the only information about the document is the document's IDD. Neither the MLD nor the EDD are required for document and content recognition. In addition, of course, the actual document is not available during the run time. However, for modifications to the design, the original EDD is stored in the IDD, but not available during the run time. In addition, the IDD uniquely identifies the MLD used to generate it. For an illustrative description of the IDD, see appendix C.

Markup Language Description

The CRM according to a preferred embodiment is flexible enough to handle an arbitrary XML document. While an approach of hard-coding CRM for various XML languages may seem reasonable, it is easier to debug and experiment with the MLDs.

The main purpose of the MLD is to guide the CRM in generation of properties for each element of interest. The MLD has a table with all the properties that are relevant for every element type. Of course, the MLD is specific to the markup language in which the documents are written. The MLD can be stored in CRM-specific directory as a read-only file. For illustrative XML schema used in MLD, see Appendix A.

External Document Description

The MLD is written for a general document in some markup language. In many cases, the application designer (a.k.a. “the user”) may want to specify the features differentiating between documents and/or elements that the CRM has no way of knowing. The external document description, or the EDD, is used for that purpose. It is generated by an external module (such as IDT) and, together with the MLD, guides the CRM in listing of properties. The syntax for EDD is similar to the syntax for MLD; they both list properties of interest for an element. However, the MLD lists those properties for all elements with a certain name, while the EDD lists them only for a particular element of the document.

The EDD is responsible for declaring elements of interest on a document. To help ensure that an element that has not been declared in the EDD will be considered by the CRM, some elements may be declared implicitly (by the MLD) for the purpose of document recognition.

Every element of interest may also have a content ID associated with it. The CRM may be asked to retrieve any element with a content ID, and not elements without one.

Internally, the CRM uses the element ID to refer to elements. The content ID is considered an external identifier. The IDD is responsible for providing the content ID of an element to the CRM.

See Appendix B for exemplary syntax for EDD.

Content Recognition

This section describes how elements are recognized given a document and an IDD (a list of properties) for some candidate document.

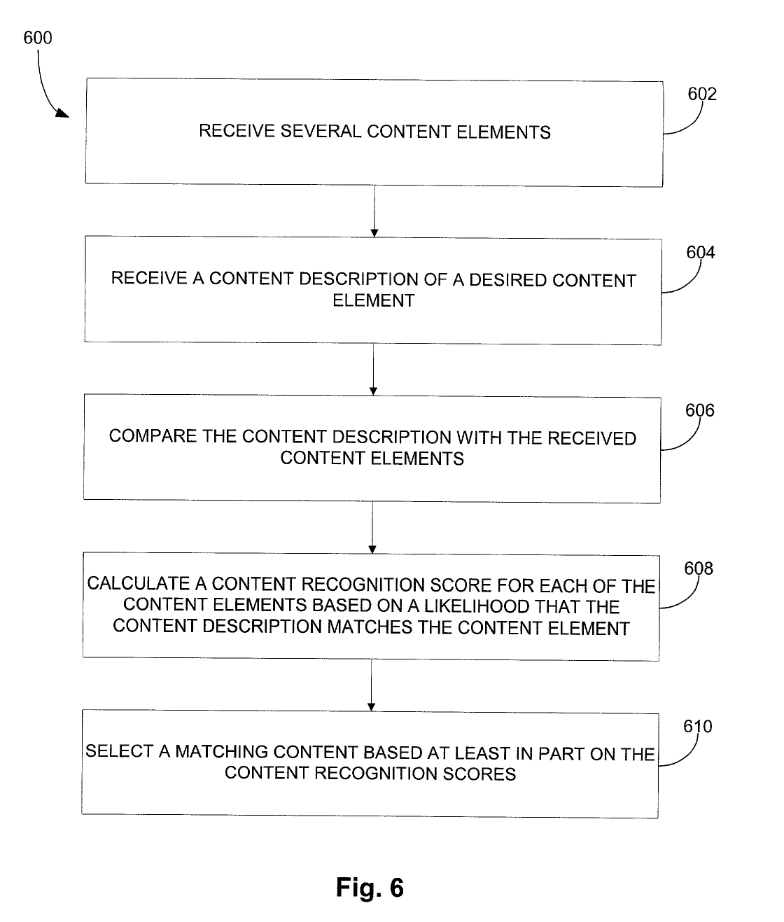

FIG. 6 is a flow diagram of a process 600 for identifying content. Several content elements are received in operation 602. In operation 604, a content description of a desired content element is received and, in operation 606, the content description is compared with the received content elements. In operation 608, a content recognition score is calculated for each of the content elements based on a likelihood that the content description matches the content element. A matching content is selected in operation 610 based at least in part on the content recognition scores.

Every element has an associated element name. Only elements with the same name are considered.

Normalization

Every element has at least one property associated with it. Upon the item's retrieval, all the property weights are normalized, i.e. they are converted to weights where the sum of all weights for an item is equal to 1. This ensures that an item with many properties does not discriminate against an item with only a few properties. For efficiency, the normalization is done when IDD is created at the design time.

Computing the Content Recognition Score

After the weights are normalized, all the candidate elements in the document are enumerated and each one is given a content recognition score which is a weighted sum of values returned by the property evaluation functions weighted with that property's normalized weight. Thus, since all property weights add up to 1 and property evaluation function returns at most 1, the retrieval score can be at most 1. These recognition scores indicate how closely a candidate element matches the one looked for. The greater the retrieval score, the better the match. The formula for the retrieval score of content item Cₖ with Nproperties is the sum:

$${R}_{k} = {\sum }_{i = 1}^{N} {w}_{i} {e}_{i}$$

where wᵢ is the normalized weight for property i and eᵢ is the value returned by property evaluation function for property i. After the recognition scores have been computed for all candidate elements, the CRM selects the element with the highest score and compares its score to some threshold. If the score is below the threshold, then the element is considered not found and its content is set to NULL. Otherwise, the element is considered found and is not considered in the search for other elements.

Computing Content Recognition Deviation

After all the properties are evaluated for every candidate element, one with the highest content recognition score is matched and returned provided it passes the threshold test. However, a question arises: what if there are several close matches? To allow the CRM to detect and handle this case, a content recognition deviation is computed from the retrieval scores. The deviation represents how close is the second (and third, etc) best matching retrieval scores to the one returned. The formula for the deviation is the harmonic mean of the absolute values of the differences between the retrieval score of matched item and that of all other items:

$${d}_{k} = {( {\sum }_{i = 1}^{k - 1} \frac{1}{\vert {R}_{i} - {R}_{k} \vert} + {\sum }_{i = k + 1}^{M} \frac{1}{\vert {R}_{i} - {R}_{k} \vert} )}^{- 1}$$

where Rₖ is the retrieval score for the best matching element indexed by k, Rᵢ is the retrieval score for element i, and M is the total number of the elements of the given type in the DOM tree. Clearly, the closer dₖ is to 0, the more likely it is that there were one or more other candidates that closely matched. If the retrieval score for k was low, then dₖ close to 0 means that the algorithm picked the best one out of a bunch of similar but badly matching candidates. If the retrieval score for k was high, then dₖ close to 0 means that the algorithm picked the best element out of severl similar, well matching candidates. If dₖ is much greater than zero, then the algorithm picked the only candidate that even remotely matched the criteria. The application should check the deviation in addition to the recognition score, to determine the likelihood of error. Note: For the purposes of the formula, assume that division by 0 results in ∞.

Pruning

It may be very inefficient to compute every property for every element in some situations. Thus, some pruning may be needed during the evaluation step. During pruning, the properties are arranged in the order of decreasing weight, and are evaluated in that order against each candidate element. As Rᵢ (retrieval score for element i) is being computed, the number Sᵢ, which is the sum of the weights of all the properties of the content item evaluated so far (at the end of the computation Sᵢ.would of course be equal to 1), is computed. Rᵢ<Sᵢ at each step in the sequence of property evaluations.

Specifically, the quantity R_{i,max}=1+S_{i,curr}+R_{i,curr} (where S_{i,curr} and R_{i,curr} are the values computed so far for Sᵢ and Rᵢ) is the maximum number Rᵢ can ever reach. The system tracks the maximum retrieval score for all candidate elements evaluated so far, called Rₘₐₓ. If at any time t, R_{,max}<Rₘₐₓ, element i can be discarded and the evaluation of properties on it stopped. For the purposes of calculating the deviation dᵢ, a final value for Rᵢ is still required. The present invention may simply use R_{i,max} here. However, there must be some small number δ that shall be used in the pruning comparison. Otherwise it is possible that Rₘₐₓ will be greater than R_{i,max} only by an insignificant amount, in which case the deviation computation would be adversely affected. In such case, the deviation could potentially become incorrectly small because pruning could cause similar recognition values to be assigned to the winning candidate and the pruned ones). The solution is as follows: to prune Rᵢ, the following inequality is created: (1−S_{i,curr}+R_{i,curr})+δ<Rₘₐₓ. After Rᵢ is pruned, it is assigned a recognition value of 1−S_{i,curr}+R_{i,curr}. This quantity is simply the upper bound for Rᵢ and is safe to use because even that upper bound would not be sufficient to make Rᵢ a significant candidate (i.e better than Rₘₐₓ). The value of δ should be some small positive number (e.g. 0.05).

Lazy Evaluation

Only in few cases would the caller of the CRM need all the content items on a document. Thus, locating an element in the document can be implemented as “lazy evaluation,” meaning that the element is located only when it is explicitly asked for. However, recognizing a document is based on the presence of certain elements, which forbids the lazy evaluation. The solution is as follows: recognition of a document stops as soon as the document is matched (see section below) and if an element was not yet located on the document, it will be located only on demand. Of course, many elements will already be located, since this is required for recognizing the document, but the benefit is that not all the elements will be located. This means that elements that are believed to successfully differentiate their owner document from another document should have their presence weight higher than other elements. This is discussed further in the section on recognizing a document.

Document Recognition

The routine responsible for recognizing a document (and individual content items) accepts all the candidate document IDDs and a document. The task is to match a single IDD to the document and then apply the content recognition algorithm to retrieve content.

The algorithm for document recognition is very similar to the algorithm for content recognition, with property weights replaced by presence weights, and with evaluation function values replaced by content recognition scores.

Normalization and Ordering

The presence weights of all elements on a document that are declared in the IDD are normalized so that their sum is equal to exactly 1.

Computing Document Recognition Score

After the weights are normalized, the document recognition score is computed for very candidate IDD as follows:

$${S}_{k} = {\sum }_{i = 1}^{N} {p}_{i} {R}_{i}$$

where N is the number of elements of interest in the IDD, pᵢ is the presence weight of element I, and Rᵢ is the content recognition score for element i.

Thus, to obtain a document recognition score, it may be necessary to obtain the content recognition scores for every element of interest. The testing of content recognition scores against a threshold is done before this computation, so Rᵢ is set to 0 if element i is not found on the document.

Computing Document Recognition Deviation

The deviation of document match is computed in the same way as the deviation for content match:

$${d}_{recognition} = {( {\sum }_{i = 1}^{k - 1} \frac{1}{\vert {S}_{i} - {S}_{k} \vert} + {\sum }_{i = k + 1}^{T} \frac{1}{\vert {S}_{i} - {S}_{k} \vert} )}^{- 1}$$

where Sᵢ is the recognition score for document i, k is the index of the matched document, and T is the number of candidate documents. Note that division by 0 results in value of ∞, and in case of a single candidate the deviation is equal to ∞ (some large number).

Pruning

Merely implementing an algorithm that calculates values for Sₜ for every document t may prove too inefficient for some situations and pruning may be necessary. Note that the formula for Sₜ does not require the ordering of document properties in the IDD; that ordering is for pruning. The pruning is very similar to that used for locating an element. A value Fₜ is calculated together with Sₜ, which is the sum of all the weights processed so far (or, looking at it another way, it is the value of Sₜ as if all property functions returned 1). At the end of the computation, Fₜ=1. At any point in the computation, the upper bound for Sₜ is 1−F_{t,curr}+S_{t,curr}, where F_{t,curr} and S_{t,curr} are the computed values of Fₜ and Sₜ so far. Thus, if for some document y, 1−F_{t,curr}+S_{t,curr}+δ<S_{y}, document t can be pruned and processing of all of its properties and elements can be stopped. See the section on pruning a content item (above) for definition of δ.

Document Hints

In many cases, as in pattern recording, the caller of the CRM needs to provide the CRM with a hint on the document match (e.g. whether some document is much more likely to match than another one, etc.). The hint consists of 2 parameters: the order of processing by which one candidate document is processed in respect to other candidates, and a hint threshold, which is a value that tells the algorithm when the document is matched (the hint threshold is a low estimate for the recognition score). The algorithm uses the hint values as follows: it starts with only one document being processed. This is the document whose order of processing is the first. The properties of the document are evaluated until either the hint threshold is reached (in which case it stops and returns that document as the match) or the recognition scores so far indicate that the hint threshold will never be reached (in which case it starts processing the document with the next processing order). However, the first document can still be processed in parallel. After determining that no document currently processed can ever reach its threshold, the next document is added (given by processing order) until none is left. Of course, the documents can still be pruned. Preferably, pruning is independent of the hints and always takes precedence.

Extreme care should be exercised when assigning hint thresholds. A low threshold may unfairly discriminate a document against other candidates and result in a wrong match.

Content Analysis

This section describes the content analysis and the process of creating an IDD from EDD, MLD, and the document itself.

Enumeration of Properties

The complete list of properties that an element needs to have is the union of all properties specified for that element by the MLD and all properties given by the user in the EDD. This list may contain duplicates such as identical properties for the same document. Also, a property that is specified in the MLD can also be specified in the EDD. The CRM does not remove duplicates, but rather treats having duplicate properties as equivalent to having a single property with the weight as the sum of all duplicates. The only implication of this is efficiency, since a same evaluation function is called several times.

How the CRM creates the list of properties may follow directly from the MLD and the EDD descriptions given in appendices A and B. The property specification in either MLD or EDD may not set the value of a computable property attribute. That value is computed by the property constructor directly from the document itself.

In addition to property enumeration, this step may add some elements to the list of elements of interest, which are not declared in the EDD. These elements are needed for document recognition, and the MLD dictates to the CRM exactly which elements must be elements of interest, regardless of the EDD.

The result of this step is the complete list of properties for every element of interest, and the complete list of elements of interest for the given document.

Setting Property Weights

After the properties are enumerated, the next step in construction of IDD is to set property weights. All the property weights must be positive (a weight of 0 implies that the property is ignored altogether). To set the weights, the properties can be grouped into four groups:

1. necessary properties—these properties are given an extremely large weight. Every necessary property must be completely satisfied by the element (the evaluation function must return 1) in order for the element to be matched. These properties can only be specified by the EDD (by the user).

2. highly important properties—these properties are given a high weight, but not as high as necessary properties, The difference is that if a necessary property fails, the match cannot occur, but if a highly important property fails, the match may still occur, depending on other properties. These properties are specified by the MLD, as well as by the EDD.

3. standard properties—these properties have standard (average importance). They are specified by either the MLD or EDD.

4. low importance properties—these properties have low importance and are specified only by the MLD.

The process of setting properties for each group is described below.

Necessary Properties

All the necessary properties have the same weight. The only requirement on the weights is that the weight of any necessary property must be greater than the sum of weights of all properties from the other 3 groups. This ensures that only those elements can match that satisfy the most of the necessary properties.

Other Properties

The remaining 3 groups get their weight set as follows: a property is evaluated not only for the element of interest, but also for all other elements in the document that have the same element name. Then a deviation is computed that measures how the result of the evaluation function applied to the current element differs from the results of the function applied to other, wrong elements. The formula for the deviation is the same as the formula for content recognition deviation and document recognition deviation; it is a harmonic mean of the absolute values of the differences. However, that formula does not suffice completely, since a property cannot have an infinite weight or a zero weight. Therefore, an upper bound is placed on the function, meaning that if a deviation is greater than the bound, it is changed to the value of that bound. Furthermore, to ensure that no deviation has a zero weight, all the deviations are incremented by some very small constant.

Then, after a deviation is obtained for every property, the deviations are multiplied by a constant specific to a property group. A high constant is used for highly important properties, a lower constant for standard properties and a low constant for low importance properties. An illustrative set of values for the constants is 3, 2, and 1.

After all the values are computed from deviations, they are normalized to add up to 1, together with all the necessary properties. A value used for a necessary property can be any number as long as it is greater that the sum of values for all other properties. This step results in setting of all property weights.

Setting Presence Weights

The presence weights are related to document analysis/recognition and not to content analysis/recognition. Hence, they are not set in content analysis. A document analysis may need to be performed even if there is only one candidate IDD.

Document Analysis

This section describes how an IDD is adjusted for document recognition in the context of several documents. Document recognition always takes place, even if there is only one candidate document. The reason for separating content and document analysis is that for every new document being added to the document pool, only the new document needs to have content analysis. The content analysis component of all other IDDs stay the same. However, adding a new document may require changing the presence weights of content elements on other documents.

Setting the Presence Weights

The presence weights are set in a way that is similar to the way the property weights are set. Just as properties of element are grouped in four groups by their weight, the elements are grouped in five groups by their presence weight. The fifth additional group is an “ignore” group (set by the EDD only for an element that is known to frequently disappear from the document), and the elements in that group have their presence weight equal to 0. Note that they still have properties, since even though they do not affect document recognition, they still need to be recognized if the user still wants to see their content when it is there.

The procedure for setting presence weights is as follows: given an element X on some document D, the CRM attempts to recognize that element X on all other documents in the document pool. Obviously, the other documents likely do not contain X, but the purpose is to calculate the content recognition score for X. After the content recognition scores for X are obtained for all documents, a deviation is computed that measures how the recognition score of X in D differs from the recognition score of X in other documents. The calculation of the deviation is identical to that described in the section discussing content analysis. The rest of the procedure is identical to the one described in setting property weights in the section on content analysis.

Optimizing the IDD

After all the property weights and presence weights are set, they are normalized and all elements are ordered by the order of decreasing presence weight. Within an element, all its properties are ordered by decreasing property weight. This is done to optimize the pruning at the runtime.

Document Similarity

The present invention uses a document recognition algorithm and returns the document recognition score to determine document similarity. Of course, a character-by character comparison may be needed if the score is exactly 1 in order to determine whether the documents are identical. If they are not identical, the score can be lowered down by a very small amount. A document analysis can be performed every time a new document is added to the set.

While various embodiments have been described above, it should be understood that they have been presented by way of example only, and not limitation. Therefore, the breadth and scope of a preferred embodiment should not be limited by any of the above-described exemplary embodiments, but should be defined only in accordance with the following claims and their equivalents.

What is claimed is:

1. A method for creating a description of a document of a remote network data source for later identification of the document, comprising:
(a) receiving information from a user about a document on a remote network data site;
(b) creating a document identifier based on the user-input information, wherein the document identifier identifies the particular document;
(c) retrieving a markup language description defining properties of elements of a document in a markup language;
(d) analyzing the document and the content of the document utilizing the document identifier and the markup language description;
(e) generating a description of the document based on the analysis; and
(f) storing the document description.

2. The method as recited in claim 1, wherein information received from the user includes at least one of: an identification of content of interest in the document, guidelines for recognizing a document, and guidelines for recognizing content elements of interest.

3. The method as recited in claim 1, wherein the document description contains a list of elements of interest and element properties for the elements of interest.

4. The method as recited in claim 1, wherein the analysis of the content is for identifying elements of interest of the content of the document.

5. The method as recited in claim 4, wherein the markup language description is used to identify properties of each of the elements of interest.

6. The method as recited in claim 5, wherein the elements of interest of the content are identified based on properties of each element.

7. The method as recited in claim 1, wherein the document analysis includes comparing the document to at least one other document, wherein the document description is modified to reflect at least one difference between the documents.

8. The method as recited in claim 1, further comprising comparing the document to at least one other document, wherein document descriptions of each of the documents are modified to reflect at least one difference between the documents.

9. The method as recited in claim 1, wherein the document is modified, wherein the document identifier is modified, wherein the modified document is analyzed for modifying the document description.

10. The method as recited in claim 9, wherein the document analysis includes comparing the modified document to at least one other document, wherein the document description is modified to reflect at least one difference between the documents.

11. The method as recited in claim 1, wherein the method is performed during creation of a transaction pattern.

12. A computer program product for creating a description of a document of a remote network data source for later identification of the document, comprising:
(a) computer code for receiving information from a user about a document on a remote network data site;
(b) computer code for creating a document identifier based on the user-input information, wherein the document identifier identifies the particular document;
(c) computer code for retrieving a markup language description defining properties of elements of a document in a markup language;
(d) computer code for analyzing the document and the content of the document utilizing the document identifier and the markup language description;
(e) computer code for generating a description of the document based on the analysis; and
(f) computer code for storing the document description.

13. The computer program product as recited in claim 12, wherein information received from the user includes at least one of: an identification of content of interest in the document, guidelines for recognizing a document, and guidelines for recognizing content elements of interest.

14. The computer program product as recited in claim 12, wherein the document description contains a list of elements of interest and element properties for the elements of interest.

15. The computer program product as recited in claim 12, wherein the analysis of the content is for identifying elements of interest of the content of the document.

16. The computer program product as recited in claim 12, wherein the document analysis includes comparing the document to at least one other document, wherein the document description is modified to reflect at least one difference between the documents.

17. The computer program product as recited in claim 12, further comprising computer code for comparing the document to at least one other document, wherein document descriptions of each of the documents are modified to reflect at least one difference between the documents.

18. The computer program product as recited in claim 12, wherein the computer program is executed during creation of a transaction pattern.

19. A system for creating a description of a document of a remote network data source for later identification of the document, comprising:
(a) logic for receiving information from a user about a document on a remote network data site;
(b) logic for creating a document identifier based on the user-input information, wherein the document identifier identifies the particular document;
(c) logic for retrieving a markup language description defining properties of elements of a document in a markup language;
(d) logic for analyzing the document and the content of the document utilizing the document identifier and the markup language description;
(e) logic for generating a description of the document based on the analysis; and
(f) logic for storing the document description.

20. A method for creating a description of content of a remote network data source for later identification of the content, comprising:
(a) receiving information from a user about content on a remote network data site;
(b) creating a content identifier based on the user-input information, wherein the content identifier identifies the particular content;
(c) retrieving a markup language description defining properties of elements of the content in a markup language;
(d) analyzing the content utilizing the content identifier and the markup language description;
(e) generating a description of the content based on the analysis; and
(f) storing the content description.

21. The method as recited in claim 20, wherein information received from the user includes at least one of: an identification of content elements of interest, guidelines for recognizing content, and guidelines for recognizing content elements of interest.

22. The method as recited in claim 20, wherein the content description contains a list of elements of interest and element properties for the elements of interest.

23. The method as recited in claim 20, wherein the content is a document.

24. The method as recited in claim 23, wherein a description of content items of the document is stored.

25. A method for identifying a document, comprising:
(a) receiving a document;
(b) receiving document descriptions of several documents;
(c) comparing the document descriptions with the document;
(d) calculating a document recognition score for each of the document descriptions based on a likelihood that the document description matches the document;
(e) selecting a document description based at least in part on the document recognition scores; and
(f) identifying the document based on the selected document description.

26. The method as recited in claim 25, wherein the document recognition score is based at least in part on recognizing properties of elements of the documents in the document descriptions.

27. The method as recited in claim 26, wherein each of the properties is given a weight.

28. The method as recited in claim 27, wherein the weights are normalized.

29. The method as recited in claim 28, wherein selected elements of the document are each given a content recognition score, wherein the content recognition score is a weighted sum of values returned by a property evaluation function weighted with the normalized weight of the property, wherein the content recognition scores are used to determine whether each content element is present.

30. The method as recited in claim 29, wherein the document recognition score for each document description is calculated using the formula
$${S}_{k} = {\sum }_{i = 1}^{N} {p}_{i} {R}_{i} ,$$
wherein N is a number of elements of interest in the document, pᵢ is the presence weight of element I, and Rᵢ is a function of the content recognition score for element i.

31. The method as recited in claim 25, wherein the selection of the document is based on the document recognition scores and deviation, wherein the deviation is computed from the document recognition scores.

32. The method as recited in claim 31, wherein a document description with a high document recognition score relative to other candidate document descriptions and a deviation above a predetermined threshold is selected.

33. The method as recited in claim 31, wherein a document description with a low document recognition score relative to other candidate document descriptions and a deviation above a predetermined threshold is selected.

34. The method as recited in claim 31, wherein the deviation is calculated using the formula
$${d}_{recognition} = {( {\sum }_{i = 1}^{k - 1} \frac{1}{\vert {S}_{i} - {S}_{k} \vert} + {\sum }_{i = k + 1}^{T} \frac{1}{\vert {S}_{i} - {S}_{k} \vert} )}^{- 1} ,$$
where Sᵢ is the recognition score for document i, k is the index of the matched document, and T is the number of candidate documents.

35. The method as recited in claim 25, further comprising pruning for reducing processing.

36. The method as recited in claim 25, further comprising retrieving portions of the document.

37. The method as recited in claim 36, wherein the portion is retrieved using a content identifier pre-associated with the portion.

38. The method as recited in claim 25, wherein the method is performed during replay of a transaction pattern.

39. The method as recited in claim 25, wherein a hint is received, wherein the hint indicates that one document description is more likely to match the document than another document description.

40. The method as recited in claim 38, wherein the hint includes an order of processing by which one document description is processed in respect to other documents descriptions.

41. The method as recited in claim 38, wherein the hint includes a hint threshold, wherein the hint threshold is a value for determining when a document description matches the document.

42. The method as recited in claim 38, wherein the hint includes an order of processing by which one document description is processed in respect to other documents descriptions, and a hint threshold, wherein the hint threshold is a value that tells the algorithm when the document is matched.

43. A computer program product for identifying a document, comprising:
(a) computer code for receiving a document;
(b) computer code for receiving document descriptions of several documents;
(c) computer code for comparing the document descriptions with the document;
(d) computer code for calculating a document recognition score for each of the document descriptions based on a likelihood that the document description matches the document;
(e) computer code for selecting a document description based at least in part on the document recognition scores; and
(f) computer code for identifying the document based on the selected document description.

44. A method for identifying content, comprising:
(a) receiving several content elements;
(b) receiving a content description of a desired content element;
(c) comparing the content description with the received content elements;
(d) calculating a content recognition score for each of the content elements based on a likelihood that the content description matches the content element; and
(e) selecting a matching content based at least in part on the content recognition scores.

45. A method for creating a description of a document of a remote network data source for later identification of the document, comprising:
(a) receiving information from a user about a document on a remote network data site, wherein the information received from the user includes at least one of: an identification of content of interest in the document, guidelines for recognizing a document, and guidelines for recognizing content elements of interest;
(b) creating a document identifier based on the user-input information, wherein the document identifier identifies the particular document;
(c) retrieving a markup language description defining properties of elements of a document in a markup language;
(d) comparing the document to at least one other document utilizing the document identifier and the markup language description;
(e) analyzing the content of the document utilizing the document identifier and the markup language description for identifying elements of interest of the content of the document;
(f) generating a description of the document based on the comparison and analysis, wherein the document description contains a list of the elements of interest and element properties for the elements of interest, wherein the document description reflects at least one difference between the document and the at least one other document; and
(g) storing the document description.
